(19) United States
(12) Patent Application Publication
(10) Pub. No.: US 2016/0370831 A1
(43) Pub. Date: Dec. 22, 2016

(54) COMMUNICATION DEVICE

(71) Applicant: FUJITSU LIMITED, Kawasaki-shi (JP)

(72) Inventors: Hiroyoshi Sato, Oyama (JP); Nobuyuki Nuimura, Kawasaki (JP); Hitoshi Suzuki, Oyama (JP); TOSHINORI IIOKA, Kawasaki (JP)

(73) Assignee: FUJITSU LIMITED, Kawasaki-shi (JP)

(21) Appl. No.: 15/137,658

(22) Filed: Apr. 25, 2016

(30) Foreign Application Priority Data
Jun. 17, 2015 (JP) 2015-122312

(51) Int. Cl. G06F 1/26; H04W 88/08

(52) U.S. Cl. CPC G06F 1/26; H04W 88/08

(57) ABSTRACT

A communication device includes multiple card slots to which processing cards are attachable, multiple power supply systems that are capable of supplying a current from a power source to each of the multiple card slots, and a control unit that connects the card slot to which the processing card is attached among the multiple card slots to any of the multiple power supply systems, the number of power supply systems that is connected to the card slot to which the processing card is attached corresponding to a total consumption current of the processing card that is attached to the card slot.

### CROSS-REFERENCE TO RELATED APPLICATION

This application is based upon and claims the benefit of priority of the prior Japanese Patent Application No. 2015-122312, filed on Jun. 17, 2015, the entire contents of which are incorporated herein by reference.

### FIELD

The embodiments discussed herein are related to a communication device.

### BACKGROUND

“Processing cards”, which perform operations related to communications, are installed in a base station equipment of a mobile communication system. For example, multiple types of processing cards are installed in the base station equipment in consideration of redundancy, or the like. Furthermore, the base station equipment includes a large number of “card slots”, and a processing card is attached to the card slot while in use. Hereafter, the processing card is sometimes simply referred to as the “card”. Furthermore, hereafter, the card slot is sometimes simply referred to as the “slot”. Furthermore, the base station equipment includes multiple “power supply terminals” that are capable of supplying currents to each card slot from the power source. Each power supply terminal is connected to multiple card slots. The processing card receives the current from the power source via a power supply terminal, a back wired board (BWB), which engages with the processing card when the processing card is installed in the card slot, or the like.

Examples of related-art are described in Japanese Laid-open Patent Publication No. 2002-300118, and in Japanese Laid-open Patent Publication No. 2011-160596.

For example, the base station equipment includes M power supply systems PWR #1 to #M and N slots #1 to #N. Furthermore, for example, the power supply system PWR #1 is connected to the slots #1 to #5, the power supply system PWR #2 is connected to the slots #6 to #10, . . . , and the power supply system PWR #M is connected to the slots #(N−4) to #N. In this way, conventionally, each power supply system is related to each card slot in a fixed manner. Furthermore, the same and constant level of current is supplied to each power supply system.

However, the number and the type of processing cards, attached to the base station equipment, are different depending on the operation form of the base station equipment; therefore, it is not previously defined as to which one of the card slots the processing card is attached to. For example, there is a case where three processing cards cr #1 to #3 are attached to the slots #1 to #3 (example 1) and, in this case, the single power supply system, i.e., the power supply system PWR #1 is used for the three processing cards cr #1 to #3. However, for example, there is also a case where, among the three processing cards cr #1 to #3, the processing card cr #1 is attached to the slot #1, the processing card cr #2 is attached to the slot #7, and the processing card cr #3 is attached to the slot #14 (example 2). Thus, in this case, the three power supply systems, i.e., the power supply systems PWR #1 to #3 are used for the three processing cards cr #1 to #3. Here, for example, in the case where the three processing cards cr #1 to #3 are attached, the single power supply system is sufficient to cover the total current value. Conversely, in the case of the above-described example 2, as the three power supply systems are used, the three power supply terminals are used, although the power consumption of the base station equipment is the same. Thus, for example, in the case of the above-described example 2, the number of used power supply terminals of the base station equipment is three times as larger as that in the case of the above-described example 1.

The same problem as that described above occurs in communication devices that include multiple card slots, to which processing cards are attached, other than the base station equipment.

### SUMMARY

According to an aspect of an embodiment, a communication device includes multiple card slots to which processing cards are attachable, multiple power supply systems that are capable of supplying a current from a power source to each of the multiple card slots, and a control unit that connects the card slot to which the processing card is attached among the multiple card slots to any of the multiple power supply systems, the number of power supply systems that is connected to the card slot to which the processing card is attached corresponding to a total consumption current of the processing card that is attached to the card slot.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram that illustrates an example of a base station equipment according to a first embodiment;

FIG. 2 is a block diagram that illustrates an example of the configuration of the base station equipment according to the first embodiment;

FIG. 3 is a flowchart that illustrates an example of the operation of the base station equipment according to the first embodiment;

FIG. 4 is a table that illustrates an example of the operation of the base station equipment according to the first embodiment;

FIG. 5 is a table that illustrates an example of the operation of the base station equipment according to the first embodiment;

FIG. 6 is a table that illustrates an example of the operation of the base station equipment according to the first embodiment;

FIG. 7 is a table that illustrates an example of the operation of the base station equipment according to the first embodiment;

FIG. 8 is a table that illustrates an example of the operation of the base station equipment according to the first embodiment;

FIG. 9 is a flowchart that illustrates an example of the operation of the base station equipment according to the first embodiment;

FIG. 10 is a flowchart that illustrates an example of the operation of the base station equipment according to the first embodiment;

FIG. 11 is a table that illustrates an example of the operation of the base station equipment according to the first embodiment;

FIG. 12 is a table that illustrates an example of the operation of the base station equipment according to the first embodiment;

FIG. 13 is a table that illustrates an example of the operation of the base station equipment according to the first embodiment;

FIG. 14 is a diagram that illustrates an example of the hardware configuration of a connection control unit and a processing card according to the first embodiment; and

FIG. 15 is a flowchart that illustrates an example of the operation of the base station equipment according to a second embodiment.

### DESCRIPTION OF EMBODIMENTS

Preferred embodiments of the present invention will be explained with reference to accompanying drawings. Here, the communication device, disclosed in the subject application, is not limited to the embodiments. Furthermore, in each embodiment, the same reference numeral is applied to the component that has the same functionality and to the step for performing the same operation, and duplicated explanations are omitted.

### [a] First Embodiment

### Configuration of a Base Station Equipment

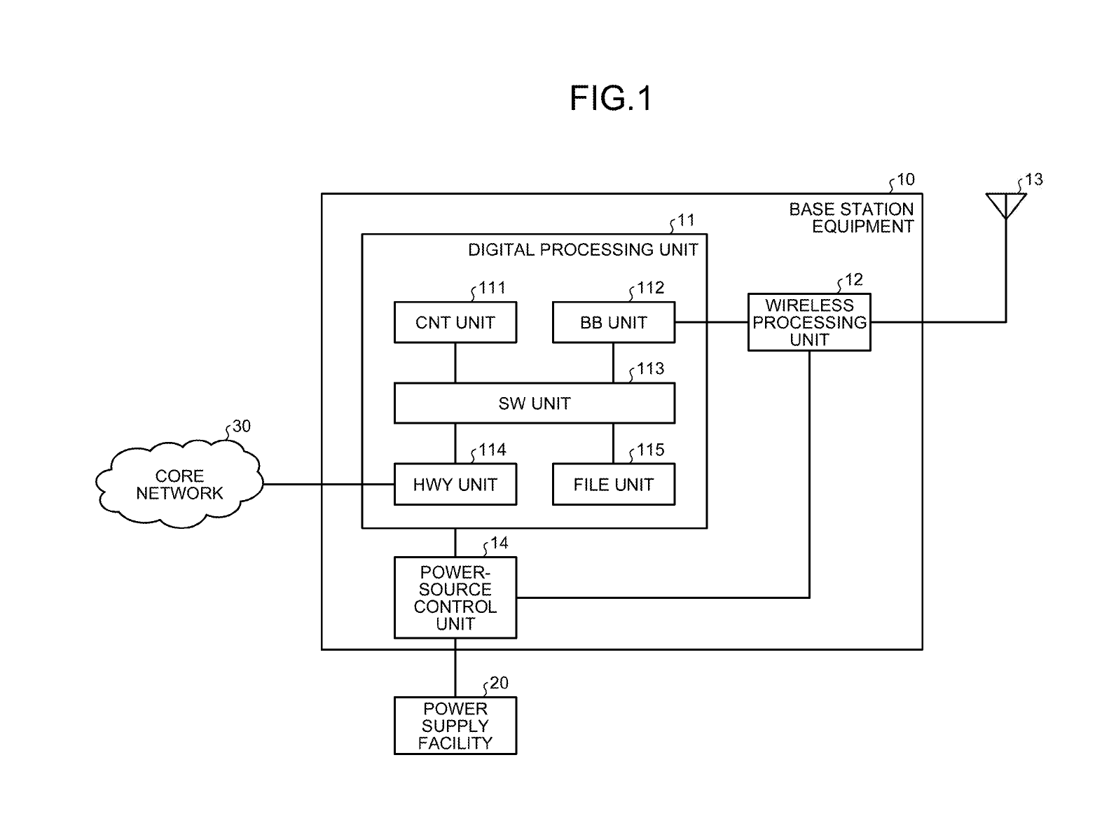

FIG. 1 is a functional block diagram that illustrates an example of a base station equipment according to a first embodiment. In FIG. 1, a base station equipment 10 includes a digital processing unit 11, a wireless processing unit 12, an antenna 13, and a power-source control unit 14. The digital processing unit 11 includes multiple processing cards that have different functions, and it includes, for example, a control (CNT) unit 111, a base band (BB) unit 112, a switch (SW) unit 113, a highway (HWY) unit 114, and a file unit 115. Furthermore, in the above-described example, it is possible to provide multiple processing cards that perform the same function. For example, for each processing card, such as the control (CNT) unit 111, the base band (BB) unit 112, the switch (SW) unit 113, the highway (HWY) unit 114, or the file unit 115, a spare card is provided one by one for a redundant configuration; thus, it is possible to contribute to quick restoration at the time of occurrence of failures. Moreover, some of the processing cards, such as the base band (BB) unit 112, may be additionally installed, as there is a need to handle an increase in the number of terminals that are accommodated by the base station equipment 10 via the antenna 13.

Power is supplied to the base station equipment 10 from a power supply facility 20 that is provided outside the base station equipment 10. Furthermore, the base station equipment 10 is connected to a core network 30.

The wireless processing unit 12 transmits or receives wireless signals via the antenna 13. The wireless processing unit 12 performs wireless receiving processing, such as down-conversion and analog-digital conversion, on received wireless signals and outputs the resultant base band signals to the BB unit 112. Furthermore, the wireless processing unit 12 performs wireless transmitting processing, such as digital-analog conversion and up-conversion, on base band signals, input from the BB unit 112, and transmits the resultant wireless signals via the antenna 13.

The BB unit 112 performs BB processing such as encoding processing and modulation processing on data, input from the HWY unit 114 via the SW unit 113, to generate base band signals and outputs the generated base band signals to the wireless processing unit 12. Furthermore, the BB unit 112 performs BB processing such as demodulation processing and decoding processing on base band signals, input from the wireless processing unit 12, and outputs the resultant data to the HWY unit 114 via the SW unit 113.

The HWY unit 114 uses an IP interface to connect the core network and the digital processing unit 11, and it performs operations on input or output data in accordance with IPsec. Specifically, IPsec is terminated by the HWY unit 114. The HWY unit 114 outputs data, input from the core network 30, to the BB unit 112 via the SW unit 113, and it outputs data, input from the BB unit 112 via the SW unit 113, to the core network 30.

The file unit 115 manages the files that are used during operations of the base station equipment 10, or the like.

The CNT unit 111 performs control on communications of the base station equipment 10, e.g., control on call connections.

The power-source control unit 14 performs control on the power source of the base station equipment 10. The power-source control unit 14 supplies currents, fed from the power supply facility 20 to the base station equipment 10, to each unit of the digital processing unit 11 and the wireless processing unit 12. The control on the power source is described later in detail.

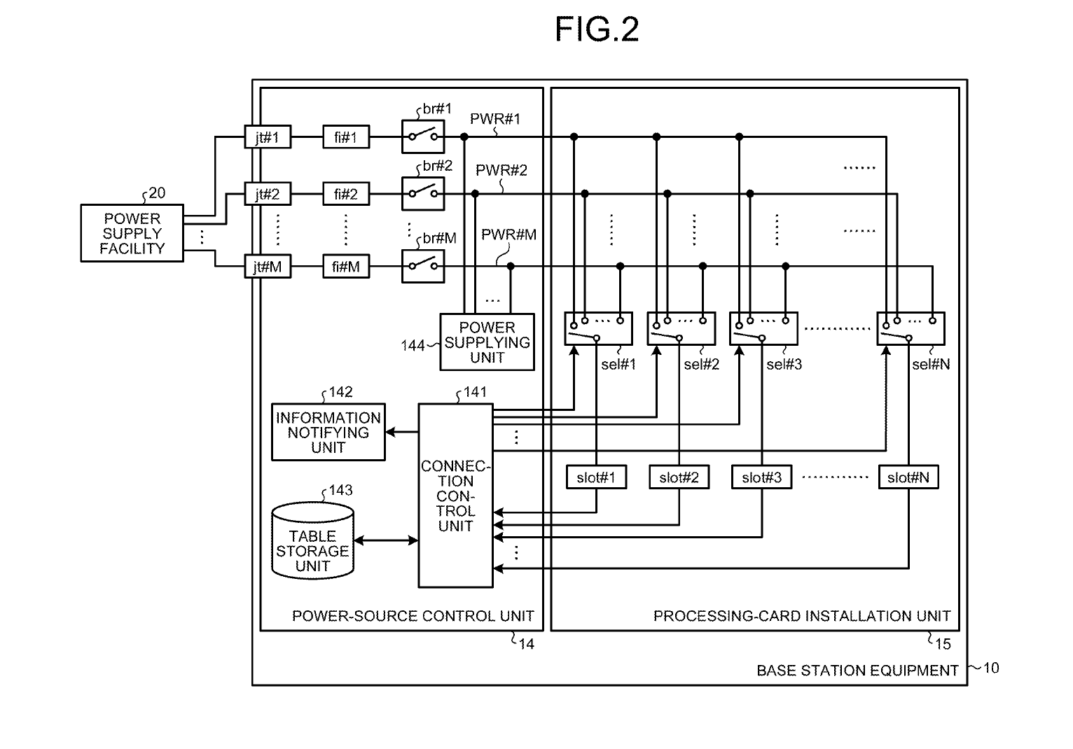

Here, the digital processing unit 11 is configured as hardware by using multiple processing cards that are equivalent to the units, i.e., the BB unit 112, the CNT unit 111, the file unit 115, the HWY unit 114, and the SW unit 113. Therefore, in hardware, the digital processing unit 11 is implemented as a “processing-card installation unit” that has multiple card slots, to which processing cards may be attached. FIG. 2 is a block diagram that illustrates an example of the configuration of the base station equipment according to the first embodiment. In FIG. 2, the base station equipment 10 includes the power-source control unit 14 and a processing-card installation unit 15.

The power-source control unit 14 includes connection terminals (i.e., power supply terminals) jt #1 to #M, filters fi #1 to #M, breakers br #1 to #M, a connection control unit 141, an information notifying unit 142, a table storage unit 143, and an power supplying unit 144.

The processing-card installation unit 15 includes selectors sel #1 to #N and the slots #1 to #N. A processing card is attachable to each of the slots #1 to #N.

The base station equipment 10 is connected to the power source, included in the power supply facility 20, via the connection terminals jt #1 to #M. One end of the power supply cable is connected to the power source, included in the power supply facility 20, and the other end of the power supply cable is connected to the connection terminals jt #1 to #M. Here, it is noted that, although M power supply cables are connected between the connection terminals jt #1 to #M and the power supply facility 20 in the example that is illustrated in FIG. 2, this is not a limitation of the present invention. For example, the power supply facility 20 is connected via the power supply cable to a specific connection terminal (e.g., the connection terminal jt #1) that supplies the electric power to the connection control unit 141 and the information notifying unit 142 among the connection terminals jt #1 to #M, and therefore, due to the operation that is described later, it is possible to determine the smallest number of connection terminals that may meet the demand for the total consumption current of the processing cards that are attached to the card slots. In this case, the connection of the power supply cable for the terminals other than the specific connection terminal may be omitted. Furthermore, for example, the power supply facility 20 is connected via the power supply cable to only the smallest number of connection terminals that may meet the demand for the total consumption current of the processing cards that are attached to the card slots among the connection terminals jt #1 to #M, and therefore the connection of the power supply facility 20 via the power supply cable to the remaining connection terminals may be omitted. Here, in consideration of additional installation of processing cards in the future, the power supply cable may be provided for some or all of the remaining connection terminals.

The filters fi #1 to #M remove noises of the currents that flow from the power supply facility 20 via the connection terminals jt #1 to #M, and they output the currents, from which noises have been removed, to the breakers br #1 to #M.

The breakers br #1 to #M are turned off (i.e., blocked) when the current equal to or more than a predetermined level flows, thereby stopping the current from being supplied to the breakers br #1 to #M and the subsequent ones. The breakers br #1 to #M are turned on by the administrator of the base station equipment 10. Furthermore, if only some terminals out of the connection terminals jt #1 to #M are connected to the power supply facility 20 via the power supply cable as described above, only the breakers that correspond to the connection terminals, which are connected to the power supply facility 20 via the power supply cable, among the breakers br #1 to #M are turned on; therefore, it is possible to omit the operation to switch the remaining breakers from off to on.

Here, the base station equipment 10 includes multiple power supply systems, i.e., the power supply systems PWR #1 to #M. The power supply system PWR #1 includes the connection terminal jt #1, the filter fi #1, and the breaker br #1, and the power supply system PWR #2 includes the connection terminal jt #2, the filter fi #2, and the breaker br #2. Furthermore, the power supply system PWR #M includes the connection terminal jt #M, the filter fi #M, and the breaker br #M.

Each of the selectors sel #1 to #N includes M input terminals and a single output terminal. The power supply systems PWR #1 to #M are connected to all the selectors sel #1 to #N (N>M) via the M input terminals of each of the selectors. The selectors sel #1 to #N are connected to the slots #1 to #N via the output terminals of the selectors sel on a one-to-one basis. Furthermore, each of the power supply systems PWR #1 to #M is connected to the power supplying unit 144.

Each of the selectors sel #1 to #N connects any one of the power supply systems PWR #1 to #M to any one of the slots #1 to #N. The connection state of each of the selectors sel #1 to #N is controlled by the connection control unit 141.

That is, the base station equipment 10 includes the power supply systems PWR #1 to #M that are capable of supplying the current from the power source, included in the power supply facility 20, to each of the slots #1 to #N and the power supplying unit 144.

When each of the slots #1 to #N has a processing card attached thereto, it outputs the information (hereafter, sometimes referred to as the “processing card information”) about the attached processing card to the connection control unit 141. An example of the processing card information is “card type information” that indicates the type of operation that is performed by the processing card.

The power supplying unit 144 supplies the current, fed from the power supply systems PWR #1 to #M, to each unit other than the processing-card installation unit 15. For example, the power supplying unit 144 supplies the current to the wireless processing unit 12 (FIG. 1), the connection control unit 141, the information notifying unit 142, and the table storage unit 143.

The table storage unit 143 stores the table that is used by the connection control unit 141. The table storage unit 143 is implemented by using, for example, a memory. Examples of the memory include a RAM such as an SDRAM, a ROM, or a flash memory.

The connection control unit 141 controls the connection states of the selectors sel #1 to #N on the basis of, for example, the card type information and the table that is stored in the table storage unit 143, thereby connecting each of the power supply systems PWR #1 to #M to each of the slots #1 to #N. Furthermore, the connection control unit 141 connects the power supply systems PWR #1 to #M to the slots, to which the processing cards are attached, among the slots #1 to #N on the basis of the total consumption current of the processing cards that are attached to the slots. For example, the connection control unit 141 connects the slots, to which the processing cards are attached, to the number of the power supply systems PWR, among the power supply systems PWR #1 to #M, that correspond to the total consumption current of the processing cards that are attached to the slots. Furthermore, the connection control unit 141 outputs the information (hereafter, sometimes referred to as the “connection state information”), indicating the connection state between the slots #1 to #N and the power supply systems PWR #1 to #M, to the information notifying unit 142. The connection control unit 141 is implemented by using, for example, a processor. Examples of the processor include a central processing unit (CPU), a digital signal processor (DSP), or a field programmable gate array (FPGA).

The information notifying unit 142 notifies, for example, the administrator of the base station equipment 10 of the connection state information. The information notifying unit 142 is implemented by using, for example, a speaker, a display, or an LED display panel, and it notifies the connection state information by using sound output, screen display, LED display, or the like.

Operation and Performance of the Base Station Equipment

An explanation is given below of the operation and performance of the base station equipment 10 separately for the time of assignment of a power supply system, the time of connection of a power supply system, and the time of additional installation of a processing card.

Operation and Performance at the Time of Assignment of a Power Supply System

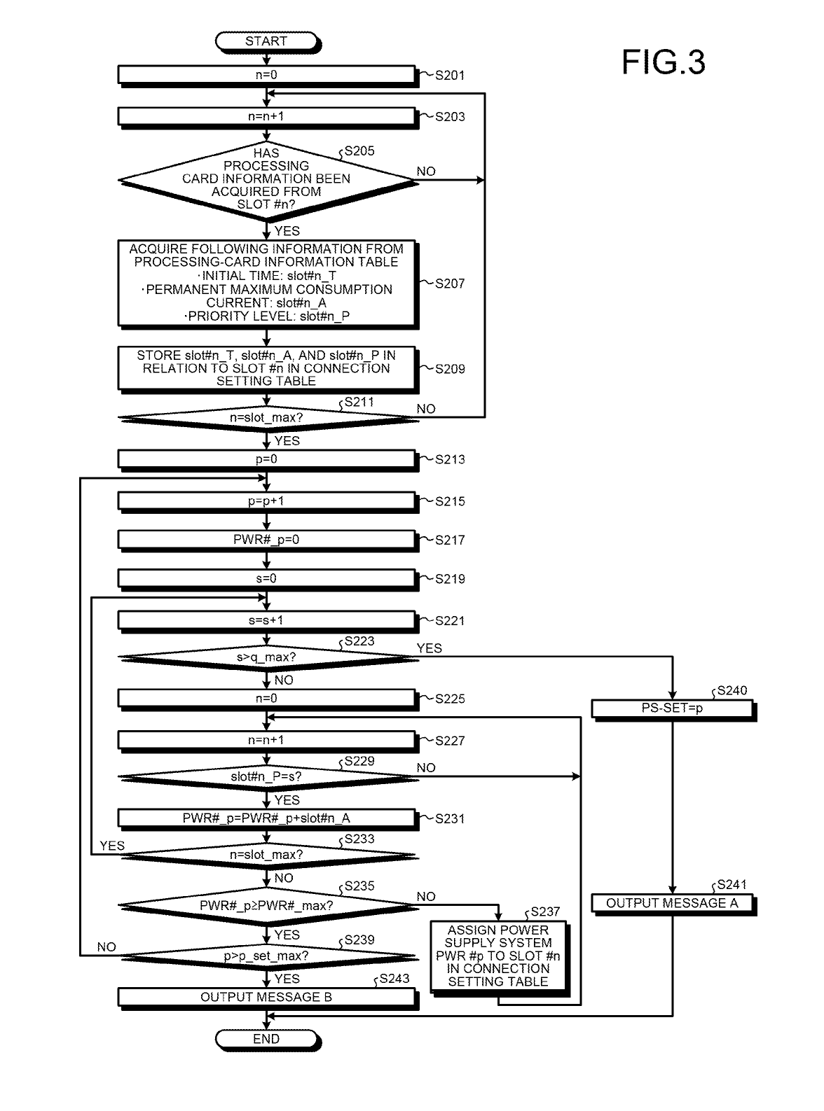

FIG. 3 is a flowchart that illustrates an example of the operation of the base station equipment according to the first embodiment. The flowchart, illustrated in FIG. 3, is started when, for example, the power source of the base station equipment 10 is turned on. Furthermore, at the start of the flowchart that is illustrated in FIG. 3, the power supplying unit 144 causes the current to be supplied to the connection control unit 141 from only any one of the power supply systems (i.e., the single power supply system) among the power supply systems PWR #1 to #M. Specifically, the connection control unit 141 uses a single power supply system among the power supply systems PWR #1 to #M to assign the power supply system to each card slot. Here, it is noted that, as the assignment operation (FIG. 3) is performed by using a single power supply system among the power supply systems PWR #1 to #M, the power-supply facility may be connected to the connection terminal, corresponding to the single power supply system, via the connection cable at the start of the flowchart that is illustrated in FIG. 3, and the connection of the power-supply facility to the remaining connection terminals via the connection cable may be omitted.

Furthermore, during the first loop that is defined by Steps S203 to S211 in the flowchart that is illustrated in FIG. 3, the information on the consumption current of each attached processing card, or the like, is acquired with regard to all the card slots, to which the processing cards are attached, among all the card slots that are included in the base station equipment 10. Furthermore, during the second loop that is defined by Steps S215 to S239, a power supply system is assigned to each card slot in ascending order of a power-supply system number p, in descending order of a processing-card priority level s (i.e., sequentially from the processing card with a higher priority level), and in ascending order of a card slot number n. Furthermore, during a third loop that is defined at Steps S221 to S233, with regard to each of the power-supply system numbers p, the consumption current of each processing card is accumulated and added in descending order of the processing-card priority level s (i.e., sequentially from the processing card with a higher priority level) and in ascending order of the card slot number n.

In FIG. 3, at Step S201, the connection control unit 141 sets the card slot number n to 0 so as to initialize the n value.

Next, at Step S203, the connection control unit 141 increments n. Thus, the card slot number n is increased by 1.

Next, at Step S205, the connection control unit 141 determines whether the processing card information has been acquired from the slot #n. If a processing card is attached to the slot #n, the connection control unit 141 may acquire the processing card information from the slot #n. Conversely, if a processing card is not attached to the slot #n, it is difficult for the connection control unit 141 to acquire the processing card information from the slot #n. Therefore, if the connection control unit 141 has acquired the processing card information from the slot #n, it determines that a processing card is attached to the slot #n. Conversely, if it is difficult for the connection control unit 141 to acquire the processing card information from the slot #n, it determines that a processing card is not attached to the slot #n. In this way, the connection control unit 141 uses a single power supply system among the power supply systems PWR #1 to #M and, on the basis of whether the processing card information is acquired from the slot #n, it detects whether a processing card is attached to the slot #n. If the connection control unit 141 has acquired the processing card information from the slot #n (Step S205: Yes), the operation proceeds to Step S207. Conversely, if it is difficult for the connection control unit 141 to acquire the processing card information from the slot #n (Step S205: No), the operation returns to Step S203 so that n is incremented. The processing card information includes the card type information.

Next, at Step S207, the connection control unit 141 refers to the “processing-card information table”, stored in the table storage unit 143, on the basis of the card type information that is acquired from the slot #n. The connection control unit 141 acquires, from the processing-card information table, an initial time slot#n_T, a permanent maximum consumption current slot#n_A, and a priority level slot#n_P, which correspond to the type of processing card that is attached to the slot #n. The initial time is the time (i.e., the initial start-up time of a processing card) from the time of start-up of the processing card until the time when the consumption current is reduced to the permanent maximum consumption current of the processing card after it is largely increased for a moment at the time of start-up of the processing card. Here, the permanent maximum consumption current is the maximum consumption current of a processing card at the time other than the initial time after the processing card is activated.

At Step S209, the connection control unit 141 stores the initial time slot#n_T, the permanent maximum consumption current slot#n_A, and the priority level slot#n_P, which are acquired at Step S207, in relation to the slot #n in a “connection setting table”, stored in the table storage unit 143.

Then, at Step S211, the connection control unit 141 determines whether n is slot_max. slot_max corresponds to the total number of card slots (i.e., the possessed slot number), included in the base station equipment 10, and it is acquired from the information that is previously stored in the memory that may be referred to by the connection control unit 141. If n is slot_max (Step S211: Yes), the operation proceeds to Step S213 and, if n is not slot_max (Step S211: No), the operation returns to Step S203 so that n is incremented. That is, the operations at Steps S205, S207, and S209 are performed on all the card slots, included in the base station equipment 10. If a determination result at Step S211 is “Yes”, the acquisition of the processing card information has been completed for all the processing cards that are attached to the card slots.

At Step S213, the connection control unit 141 sets the power-supply system number p to 0, thereby initializing the p value.

Next, at Step S215, the connection control unit 141 increments p.

Next, at Step S217, the connection control unit 141 sets a total maximum consumption current PWR#_p to 0, thereby initializing the PWR#_p value.

Next, at Step S219, the connection control unit 141 sets the priority level s to 0, thereby initializing the s value.

Then, at Step S221, the connection control unit 141 increments s.

Next, at Step S223, the connection control unit 141 determines whether s is larger than q_max. q_max corresponds to the largest value of the level of priority of a processing card, and it is acquired from the information that is previously stored in the memory that may be referred to by the connection control unit 141. For example, if “1”, “2”, and “3” are settable as the level of priority of a processing card, q_max is set to “3”. If s is larger than q_max, assignment of the power supply system has been completed with regard to all the settable levels of priority. Therefore, if s is larger than q_max (Step S223: Yes), the operation proceeds to Step S240 and, if s is equal to or less than q_max (Step S223: No), the operation proceeds to Step S225.

At Step S225, the connection control unit 141 sets the card slot number n to 0, thereby initializing the n value.

Next, at Step S227, the connection control unit 141 increments n.

Then, at Step S229, the connection control unit 141 refers to the “connection setting table”, stored in the table storage unit 143, on the basis of the card slot number n so as to acquire slot#n_P, corresponding to the card slot number n, from the connection setting table. Furthermore, the connection control unit 141 determines whether slot#n_P is s. slot#n_P corresponds to the priority level of the processing card that is attached to the slot #n. A smaller value for the priority level indicates a higher priority level. If slot#n_P is s (Step S229: Yes), the operation proceeds to Step S231 and, if slot#n_P is not s (Step S229: No), the operation returns to Step S227 so that n is incremented.

At Step S231, the connection control unit 141 accumulates and adds slot#n_A to PWR#_p. slot#n_A corresponds to the permanent maximum consumption current of the processing card that is attached to the slot #n. That is, slot#n_A that corresponds to the card slot with the number n, to which the processing card with the priority level s is attached, is accumulated and added to PWR#_p. Here, the default value of s is 1, and it is incremented. Therefore, at Step S231, the permanent maximum consumption current is accumulated and added to the total maximum consumption current in descending order of the priority level (that is, sequentially from the processing card with a higher priority level).

Next, at Step S233, the connection control unit 141 determines whether n is slot_max. If n is not slot_max (Step S233: No), the operation proceeds to Step S235 and, if n is slot_max (Step S233: Yes), the operation returns to Step S221 so that s is incremented. As s is incremented, the priority level, which is the target for accumulation and addition at Step S231, is decreased by one.

At Step S235, the connection control unit 141 determines whether PWR#_p is equal to or more than PWR#_max. PWR#_max corresponds to the maximum current that may be supplied by one power supply system, i.e., the maximum allowable consumption current per power supply system, and it is acquired from the information that is previously stored in the memory that may be referred to by the connection control unit 141. Furthermore, PWR#_p corresponds to the value that is obtained by accumulating and adding the permanent maximum consumption currents slot#n_A of the processing cards, to which the power supply system with the number p is assigned (i.e., the accumulated and added value of slot#n_A with regard to each of the power-supply system numbers p). If PWR#_p is not equal to or more than PWR#_max (Step S235: No), the operation proceeds to Step S237 and, if PWR# p is equal to or more than PWR#_max (Step S235: Yes), the operation proceeds to Step S239.

At Step S237, the connection control unit 141 stores the power-supply system number p with regard to the slot #n in the connection setting table. That is, the connection control unit 141 assigns the power supply system with the number p (i.e., the power supply system PWR #p) to the slot #n. After the operation at Step S237, the operation returns to Step S227 so that n is incremented.

At Step S239, the connection control unit 141 determines whether p is larger than p_set_max. p_set_max corresponds to the maximum number of used systems among the total number (i.e., the possessed system number) p_max of power supply systems, included in the base station equipment 10, and it is acquired from the information that is previously stored in the memory that may be referred to by the connection control unit 141. If p is larger than p_set_max (Step S239: Yes), the operation proceeds to Step S243 and, if p is equal to or less than p_set_max (Step S239: No), the operation returns to Step S215 so that p is incremented. For example, if the base station equipment 10 includes multiple power supply systems, i.e., the power supply systems PWR #1 to #M, the possessed system number is M, and it is equivalent to the number of the connection terminals jt, included in the base station equipment 10. Furthermore, the upper limit of the maximum used system number p_set_max is the possessed system number p_max, and the maximum number of systems, which are actually allowed to be used, is optionally set by, for example, the administrator of the base station equipment 10.

At Step S240, the connection control unit 141 sets PS-SET to p. That is, the largest number among the assigned power-supply system numbers is set as PS-SET.

Next, at Step S241, the connection control unit 141 outputs a message A to the information notifying unit 142, and the information notifying unit 142 notifies the message A. If the determination of “Yes” is made at Step S223 before the determination of “Yes” is made at Step S239, the value of p is a value that is equal to or less than p_set_max, and it indicates the sufficient power-supply system number for covering the power supply to all the attached processing cards. Therefore, the message A includes, for example, the message for notifying the connection states between the slots #1 to #N and the power supply systems PWR #1 to #M. Furthermore, for example, the number of connection terminals that need to be connected (i.e., the number of power supply systems that need to be connected) may be notified by using the message A. For example, the connection control unit 141 outputs the value of PS-SET to the information notifying unit 142, and the information notifying unit 142 notifies the value of PS-SET, whereby the number of connection terminals that need to be connected may be notified. For example, the information notifying unit 142 may include multiple blue LEDs that indicate normal termination and multiple red LEDs that indicate faulty termination so that, by lighting up the number of blue LEDs that is equivalent to the value of PS-SET, the number of connection terminals that need to be connected is notified.

At Step S243, the connection control unit 141 outputs a message B to the information notifying unit 142 and the information notifying unit 142 notifies the message B. The message B includes, for example, a message that notifies that the power-supply system number of p_set_max is not sufficient to cover the currents for operating all the processing cards, attached to the base station equipment 10, i.e., with the power-supply system number of p_set_max, the power-supply system number is insufficient. For example, the information notifying unit 142 may include multiple blue LEDs that indicate normal termination and multiple red LEDs that indicate faulty termination so that, by lighting up all the red LEDs, the message B is notified.

After the operations at Step S241 or S243, the operation at the time of assignment of the power supply system is terminated.

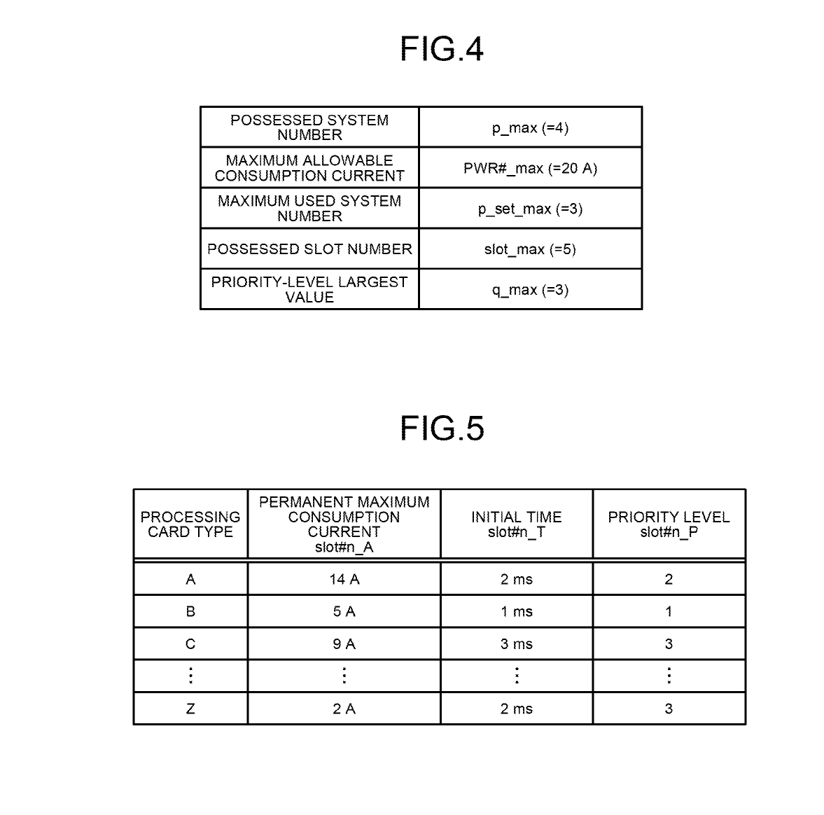

FIGS. 4 to 8 are tables that illustrate an example of the operation of the base station equipment according to the first embodiment.

For example, as illustrated in FIG. 4, the possessed system number p_max, the maximum allowable consumption current PWR#_max, the maximum used system number p_set_max, the possessed slot number slot_max, and the priority-level largest value q_max are previously set in the memory that may be referred to by the connection control unit 141. The following explanation is given, where for example p_max=4, PWR#_max=20 amperes (A), p_set_max=3, slot_max=5, and q_max=3.

FIG. 5 illustrates an example of the processing-card information table. The processing-card information table is previously stored in the table storage unit 143. The processing-card information table stores the permanent maximum consumption current slot#n_A, the initial time slot#n_T, and the priority level slot#n_P with regard to each type of processing card. For example, slot#n_A=14 A, slot#n_T=2 ms, and slot#n_P=2 with regard to the processing card of the type “A”, and slot#n_A=5 A, slot#n_T=1 ms, and slot#n_P=1 with regard to the processing card of the type “B”. A smaller value for the priority level indicates a higher priority level.

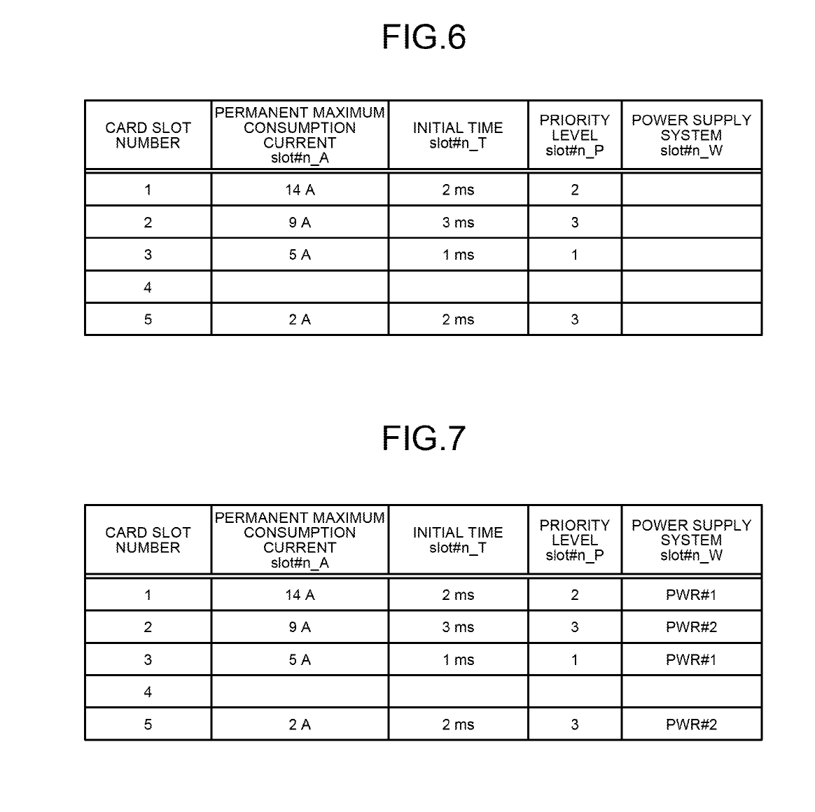

FIGS. 6 and 7 illustrate examples of the connection setting table.

First, after the operations at Step S201 to S211 of FIG. 3, the state of the connection setting table is obtained as illustrated in FIG. 6. Specifically, it is detected whether processing cards are attached to the slots #1 to #5 (i.e., the slots with the card slot numbers 1 to 5), and the processing card information is acquired from the processing card that is attached to the slot. Assume that the processing card of the type A is attached to the slot #1, the processing card of the type C to the slot #2, the processing card of the type B to the slot #3, and the processing card of the type Z to the slot #5. Furthermore, assume that a processing card is not attached to the slot #4. Therefore, the processing card information including the type A is acquired from the processing card that is attached to the slot #1, the processing card information including the type C from the processing card that is attached to the slot #2, and the processing card information including the type B from the processing card that is attached to the slot #3. The details of the processing card information are described later. The connection control unit 141 refers to the processing-card information table (FIG. 5) on the basis of the types of processing cards that are attached to the slots #1 to #3 and #5, and slot#n_A, slot#n_T, and slot#n_P, which correspond to the type of processing card, are acquired from the processing-card information table. Then, the connection control unit 141 stores slot#n_A, slot#n_T, and slot#n_P, which correspond to the type of processing card that is attached to each card slot, in relation to the slots #1 to #3 and #5 in the connection setting table (FIG. 6).

Next, after the operations at Steps S213 to S239 of FIG. 3, the state of the connection setting table is obtained as illustrated in FIG. 7. slot#n_W indicates the power supply system PWR #p that is assigned to the slot #n.

At Step S213 to S239 of FIG. 3, first, the power supply system PWR #1 is assigned to each card slot until the total maximum consumption current PWR#_p becomes the maximum allowable consumption current PWR#_max (=20 A) sequentially from the processing card with a higher priority level and in ascending order of the card slot number.

Specifically, with regard to the slot #3, to which the processing card with the priority level “1” is attached, slot#n_A is 5 A and therefore the total maximum consumption current PWR#_p is 5 A; thus, the power supply system PWR #1 is first assigned to the slot #3. Next, with regard to the slot #1, to which the processing card with the priority level “2” is attached, slot#n_A is 14 A and therefore the total maximum consumption current PWR#_p is 19 A; thus, the power supply system PWR #1 is assigned to the slot #1.

Next, with regard to the slot #2, to which the processing card with the priority level “3” is attached, slot#n_A is 9 A; therefore, the total maximum consumption current PWR#_p is 28 A and it is equal to or more than the maximum allowable consumption current PWR#_max (=20 A). Thus, the power supply system to be assigned is changed from PWR #1 to PWR #2, and the total maximum consumption current PWR#_p is reset to 0. Then, in the same manner as that described above, the power supply system PWR #2 is assigned to each card slot in ascending order of the priority level of a processing card and in ascending order of a card slot number until the total maximum consumption current PWR#_p becomes the maximum allowable consumption current PWR#_max (=20 A).

Specifically, with regard to the slot #2, to which the processing card with the priority level “3” is attached, slot#n_A is 9 A and therefore the total maximum consumption current PWR#_p is 9 A; thus, the power supply system PWR #2 is assigned to the slot #2. Next, with regard to the slot #5, to which the processing card with the priority level “3” is attached, slot#n_A is 2 A and therefore the total maximum consumption current PWR#_p is 11 A; thus, the power supply system PWR #2 is assigned to the slot #5.

The priority-level largest value q_max is “3”; therefore, after the power supply system PWR #2 is assigned to the slot #5, the determination result at Step S223 of FIG. 3 is “Yes”, and the operation proceeds to Step S240.

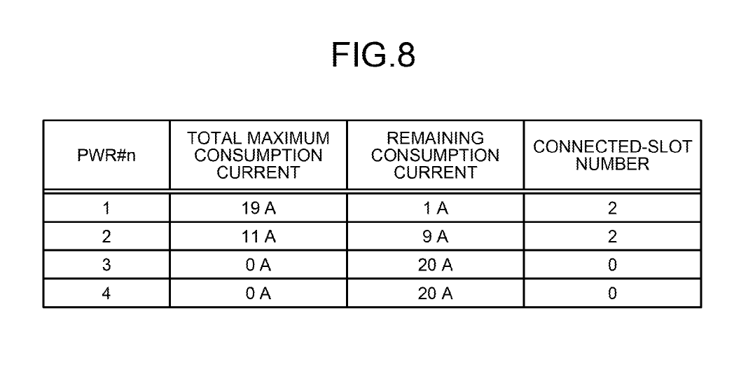

At Step S241, the connection control unit 141 generates for example “display information table”, illustrated in FIG. 8, in order to output the message A. FIG. 8 illustrates that the two card slots are assigned and connected to each of the power supply system PWR #1 and the power supply system PWR #2. It is illustrated that no card slots are connected to the power supply system PWR #3 and the power supply system PWR #4. That is, it is illustrated that only the two power supply systems, i.e., the power supply systems PWR #1 and PWR #2, are sufficient to operate all the processing cards (here, the four processing cards), attached to the base station equipment 10, among all the four power supply systems, i.e., the power supply systems PWR #1 to PWR #4. Furthermore, with regard to the power supply system PWR #1, it is illustrated that the total of the maximum consumption currents of the two card slots, connected to the power supply system PWR #1, is 19 A (=5 A+14 A) and the remaining consumption current is 1 A (=20 A-19 A). Furthermore, with regard to the power supply system PWR #2, it is illustrated that the total of the maximum consumption currents of the two card slots, connected to the power supply system PWR #2, is 11 A (=9 A+2 A) and the remaining consumption current is 9 A (=20 A-11 A). Therefore, in the case of FIG. 8, the total consumption current of the processing cards, attached to the card slots, is 30 A (=19 A+11 A). The connection control unit 141 outputs the message A to the information notifying unit 142 on the basis of the contents of the display information table, illustrated in FIG. 8, and the information notifying unit 142 notifies the message A. Furthermore, the connection control unit 141 outputs the display information table, illustrated in FIG. 8, to the table storage unit 143, and the table storage unit 143 stores the display information table.

Due to the notification of the message A, the administrator of the base station equipment 10 determines that only the power supply systems PWR #1 and PWR #2 are sufficient to operate all the processing cards, attached to the base station equipment 10, among all the power supply systems PWR #1 to PWR #4. Therefore, the administrator of the base station equipment 10 turns on only the breakers br #1 and br #2 among all the breakers br #1 to #4, included in the base station equipment 10, while the breakers br #3 and br #4 are off. Thus, the base station equipment 10 supplies the current by using only the two power supply systems, i.e., the power supply systems PWR #1 and PWR #2, among all the four power supply systems, i.e., the power supply systems PWR #1 to PWR #4.

Operation and Performance at the Time of Connection of a Power Supply System

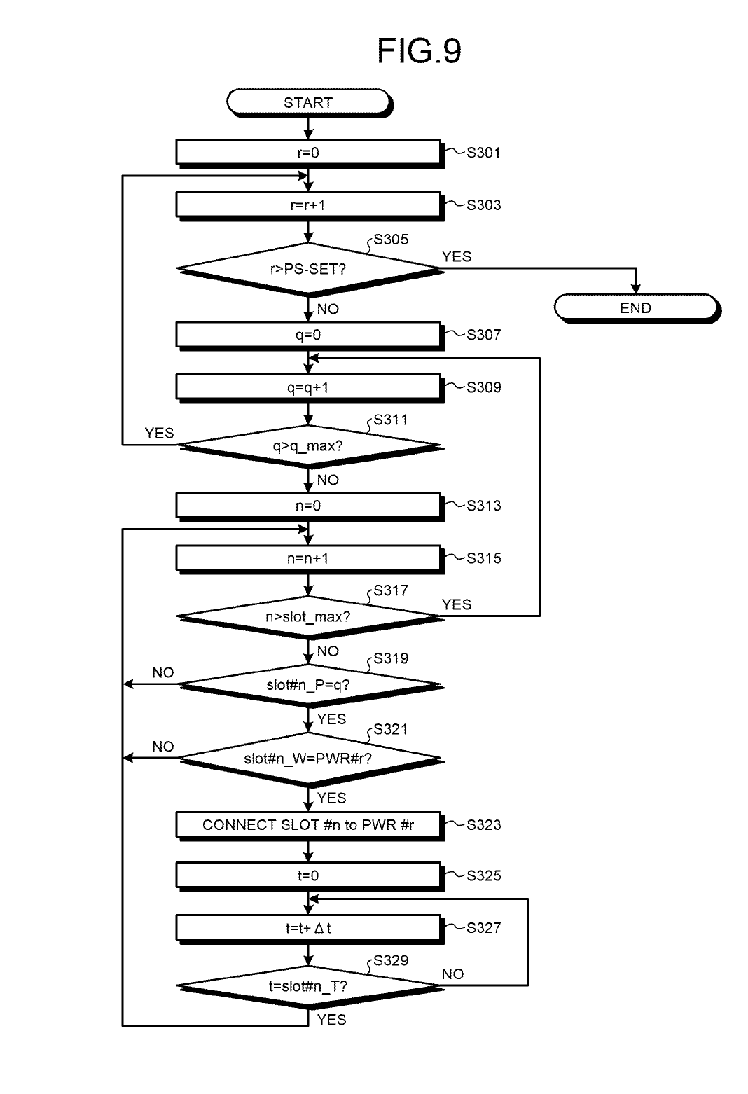

FIG. 9 is a flowchart that illustrates an example of the operation of the base station equipment according to the first embodiment. The flowchart illustrated in FIG. 9 is started, for example, after the determination result “Yes” is obtained at Step S223 of the flowchart that is illustrated in FIG. 3. When the determination result at Step S223 is “Yes”, generation of the connection setting table on the basis of all the attached processing cards has been completed, and preparations have been made to connect the power supply system to a processing card. Furthermore, at the start of the flowchart illustrated in FIG. 9, the power supplying unit 144 causes the current to be supplied to the connection control unit 141 from only any one of the power supply systems PWR #1 to #M (i.e., the single power supply system). Specifically, the connection control unit 141 uses a single power supply system among the power supply systems PWR #1 to #M to connect each card slot to the power supply system. Furthermore, at the start of the flowchart illustrated in FIG. 9, the state is obtained such that the slots #1 to #N and the power supply systems PWR #1 to #M are not connected in any one of the selectors sel #1 to #N (FIG. 2).

In the flowchart that is illustrated in FIG. 9, each card slot is connected to a power supply system in ascending order of a power-supply system number r, in descending order of a priority level q of a processing card (that is, sequentially from a processing card with a higher priority level), and in ascending order of the number n of the card slot, to which the processing card is attached.

In FIG. 9, at Step S301, the connection control unit 141 sets the power-supply system number r to 0, thereby initializing the r value.

Next, at Step S303, the connection control unit 141 increments r.

Next, at Step S305, the connection control unit 141 determines whether r is larger than PS-SET, which is set at Step S240 of FIG. 3. If r is larger than PS-SET (Step S305: Yes), the operation at the time of connection of the power supply system is terminated. Conversely, if r is equal to or less than PS-SET (Step S305: No), the operation proceeds to Step S307.

At Step S307, the connection control unit 141 sets the priority level q to 0, thereby initializing the q value.

Next, at Step S309, the connection control unit 141 increments q.

Then, at Step S311, the connection control unit 141 determines whether q is larger than q_max. If q is larger than q_max (Step S311: Yes), the operation returns to Step S303 so that r is incremented. Conversely, if q is equal to or less than q_max (Step S311: No), the operation proceeds to Step S313.

At Step S313, the connection control unit 141 sets the card slot number n to 0, thereby initializing the n value.

Next, at Step S315, the connection control unit 141 increments n.

Next, at Step S317, the connection control unit 141 determines whether n is larger than slot_max. If n is larger than slot_max (Step S317: Yes), the operation returns to Step S309 so that q is incremented. Conversely, if n is equal to or less than slot_max (Step S317: No), the operation proceeds to Step S319.

At Step S319, the connection control unit 141 determines whether slot#n_P is q. slot#n_P corresponds to the priority level of the processing card that is attached to the slot #n. If slot#n_P is q (Step S319: Yes), the operation proceeds to Step S321 and, if slot#n_P is not q (Step S319: No), the operation is returned to Step S315 so that n is incremented.

At Step S321, the connection control unit 141 refers to the connection setting table (FIG. 7) to determine whether slot#n_W is a power supply system PWR #r. slot#n_W indicates the power supply system PWR #r that is assigned to the slot #n. If slot#n_W is PWR #r (Step S321: Yes), the operation proceeds to Step S323 and, if slot#n_W is not PWR #r (Step S321: No), the operation returns to Step S315 so that n is incremented.

At Step S323, the connection control unit 141 controls the selector sel #k so as to connect the slot #n to the power supply system PWR #r.

Next, at Step S325, the connection control unit 141 sets a stand-by time t to 0.

Then, at Step S327, the connection control unit 141 accumulates and adds Δt to t. Δt is, for example, 1 ms.

Next, at Step S329, the connection control unit 141 refers to the connection setting table (FIG. 7) to determine whether t is slot#n_T. slot#n_T indicates the initial time of the slot #n. If t is slot#n_T (Step S329: Yes), the operation returns to Step S315 so that n is incremented. Conversely, if t is not slot#n_T (Step S329: No), the operation returns to Step S327 so that At is accumulated and added to t. That is, during the operation at Steps S325 to S329, after connecting the slot #n to the power supply system, the connection control unit 141 connects the slot #n+1 to the power supply system with an interval of the initial time of the processing card that is attached to the slot #n. Furthermore, at Step S329, the connection control unit 141 may determine whether t is slot#n_T+α. For example, the value of 10% of slot#n_T is set as the value of α.

Here, during the initial time, the current equal to or more than the permanent maximum consumption current is consumed by the processing card due to the initial settings of the processing card, the current charge into the capacitor within the processing card, or the like. Therefore, the connection is established “with an interval of the initial time” as described above, whereby it is possible to prevent turn-off of the breaker due to the excess of the maximum allowable consumption current per single power supply system.

An explanation is given below of an example of the operation at the time of connection of the power supply system.

The connection control unit 141 refers to the connection setting table (FIG. 7) to connect the card slot to the power supply system in ascending order of the power-supply system number r, in ascending order of the priority level q, and in ascending order of the card slot number n. Furthermore, the connection control unit 141 connects the slot #n+1 to the power supply system with an interval of the initial time slot#n_T of the processing card that is attached to the slot #n from the time when the slot #n is connected to the power supply system.

Specifically, first, the slot #3 with the priority level “1” is connected to the power supply system PWR #1, indicated in the connection setting table (FIG. 7). Then, the slot #1 with the priority level “2” is connected to the power supply system PWR #1 with a delay of 1 ms from the time when the slot #3 is connected. Then, the slot #2 with the priority level “3” is connected to the power supply system PWR #2 with a delay of 2 ms from the time when the slot #1 is connected. Then, the slot #5 with the priority level “3” is connected to the power supply system PWR #2 with a delay of 3 ms from the time when the slot #2 is connected.

Operation and Performance at the Time of Additional Installation of a Processing Card

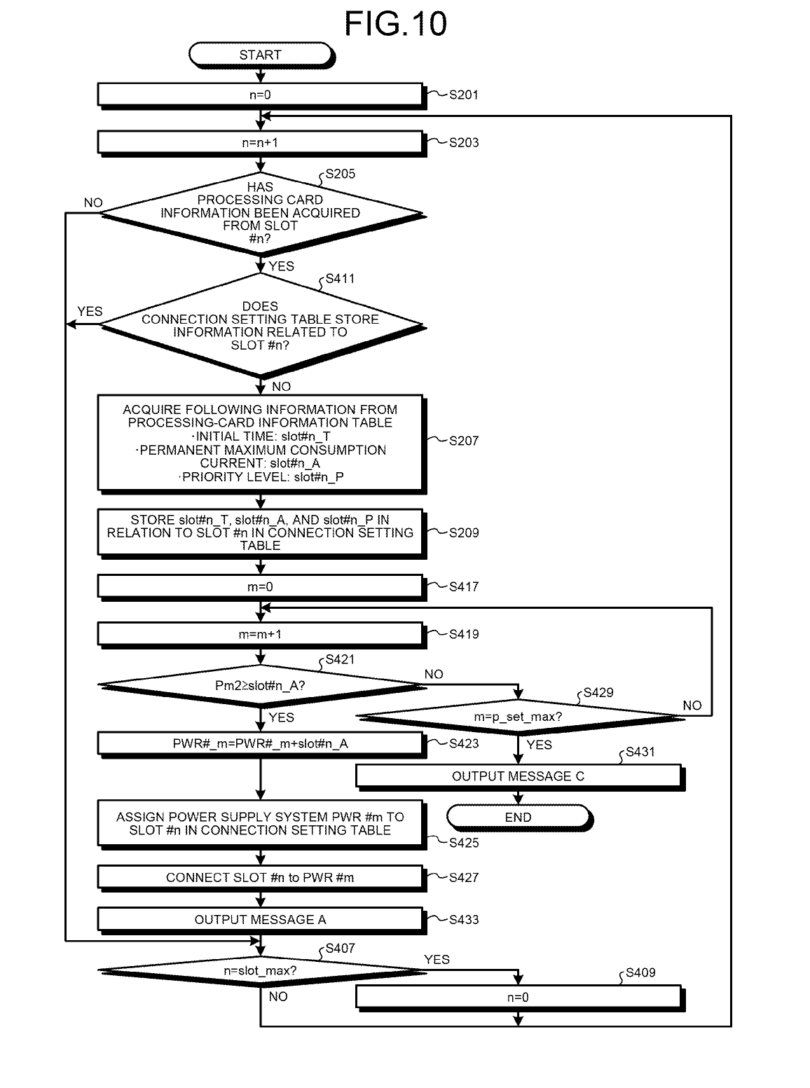

FIG. 10 is a flowchart that illustrates an example of the operation of the base station equipment according to the first embodiment. The flowchart illustrated in FIG. 10 is started, for example, after the flowchart illustrated in FIG. 9 is terminated. When the flowchart of FIG. 9 is terminated, the power supply systems are connected to all the attached processing cards before a processing card is additionally installed.

In the flowchart that is illustrated in FIG. 10, after acquisition of the information on the consumption current, or the like, of the additionally installed processing card, i.e., the new processing card that is attached to the card slot, each power supply system is assigned to the card slot, to which the new processing card is attached, in ascending order of a power-supply system number m and in ascending order of the card slot number n. Furthermore, after assignment of the power supply system, the card slot, to which the new processing card is attached, is connected to the power supply system.

The operations at Steps S201 to S205 in FIG. 10 are the same as those in FIG. 3; therefore the explanations are omitted.

If the connection control unit 141 has acquired the processing card information from the slot #n (Step S205: Yes), the operation proceeds to Step S411. Conversely, if it is difficult for the connection control unit 141 to acquire the processing card information from the slot #n (Step S205: No), the operation proceeds to Step S407.

At Step S407, the connection control unit 141 determines whether n is slot_max. If n is slot_max (Step S407: Yes), the connection control unit 141 sets n to 0 so as to initialize the n value at Step S409, and the operation returns to Step S203 so that n is incremented. Conversely, if n is not slot_max (Step S407: No), the operation returns to Step S203 so that n is incremented.

At Step S411, the connection control unit 141 determines whether the connection setting table stores the information related to the slot #n, i.e., whether various types of information, such as slot#n_A, slot#n_T, slot#n_P, and slot#n_W, are stored in relation to the slot #n. If the connection setting table stores the information related to the slot #n (Step S411: Yes), the operation returns to Step S407. Conversely, if the connection setting table does not store the information related to the slot #n (Step S411: No), the operation proceeds to Step S207.

As the operations at Steps S207 and S209 are the same as those in FIG. 3, the explanations are omitted.

At Step S417, the connection control unit 141 sets the power-supply system number m to 0, thereby initializing the m value.

Next, at Step S419, the connection control unit 141 increments m.

Next, at Step S421, the connection control unit 141 determines whether Pm2 is equal to or more than slot#n_A. Pm2 corresponds to the remaining consumption current of a power supply system PWR #m, and the connection control unit 141 refers to the display information table (FIG. 8), stored in the table storage unit 143, to acquire the remaining consumption current of the power supply system PWR #m. Furthermore, slot#n_A corresponds to the permanent maximum consumption current of the processing card that is attached to the slot #n. If Pm2 is equal to or more than slot#n_A (Step S421: Yes), the operation proceeds to Step S423 and, if Pm2 is less than slot#n_A (Step S421: No), the operation proceeds to Step S429.

At Step S423, the connection control unit 141 accumulates and adds slot#n_A to PWR# m. PWR# m corresponds to the total maximum consumption current of the power supply system PWR #m. The connection control unit 141 refers to the display information table (FIG. 8), stored in the table storage unit 143, to acquire the default value of the total maximum consumption current of the power supply system PWR #m.

Next, at Step S425, the connection control unit 141 stores the power-supply system number m in relation to the slot #n in the connection setting table. That is, the connection control unit 141 assigns the power supply system with the number m (i.e., the power supply system PWR #m) to the slot #n.

Then, at Step S427, the connection control unit 141 controls a selector sel #n so as to connect the slot #n to the power supply system PWR #m.

Then, at Step S433, the connection control unit 141 outputs the message A to the information notifying unit 142, and the information notifying unit 142 notifies the message A.

Furthermore, at Step S429, the connection control unit 141 determines whether m is p_set_max. If m is p_set_max (Step S429: Yes), the operation proceeds to Step S431 and, if m is not p_set_max (Step S429: No), the operation returns to Step S419 so that m is incremented.

At Step S431, the connection control unit 141 outputs a message C to the information notifying unit 142, and the information notifying unit 142 notifies the message C. The message C includes, for example, a message that notifies that it is difficult to additionally install a processing card because of the power-supply system number of p_set_max.

After the operation at Step S431, the operation at the time of additional installation of the processing card is terminated.

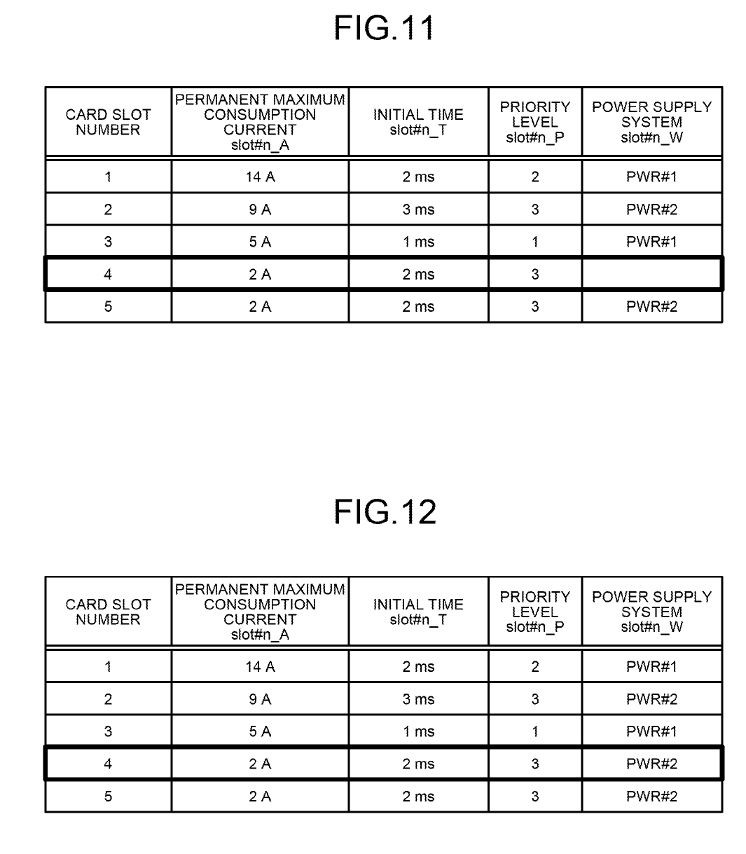

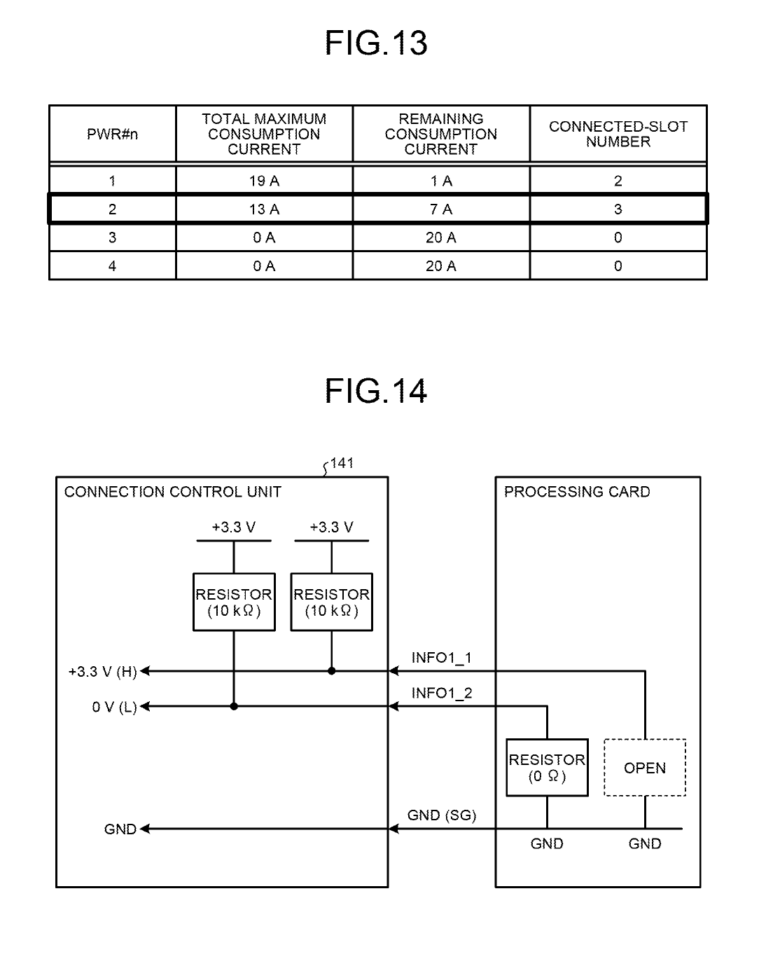

FIGS. 11 to 13 are tables that illustrate an example of the operation of the base station equipment according to the first embodiment. FIGS. 11 and 12 illustrate an example of the connection setting table, and FIG. 13 illustrates an example of the display information table. An explanation is given below of a case where a processing card of the type Z is additionally installed in the slot #4.

During the operations at Steps S201 to S209 and S407 to S411 of FIG. 10, the state of the connection setting table, illustrated in FIG. 7, is updated to the state that is illustrated in FIG. 11. Specifically, it is detected whether a processing card is attached to the slot #4 with the card slot number 4, and the processing card information is acquired from the slot #4, to which the processing card is attached. The connection control unit 141 refers to the processing-card information table (FIG. 5) on the basis of the type Z of the processing card that is attached to the slot #4, thereby acquiring slot#n_A (=2 A), slot#n_T (=2 ms), and slot#n_P (=3), which correspond to the type Z, from the processing-card information table. Then, the connection control unit 141 stores slot#n_A, slot#n_T, and slot#n_P, which correspond to the type Z, in relation to the slot #4 in the connection setting table (FIG. 6).

Then, during the operations at Steps S417 to S425 and S429 of FIG. 10, the connection setting table is changed into the state that is illustrated in FIG. 12.

At Step S421 in FIG. 10, in ascending order of the power-supply system number, it is checked whether the remaining consumption current of the power supply system is equal to or more than the permanent maximum consumption current of the additionally installed processing card. Then, if the power supply system includes the remaining consumption current that is equal to or more than the permanent maximum consumption current of the additionally installed processing card, it is assigned to the card slot, to which the additionally installed processing card is attached. Specifically, although the permanent maximum consumption current of the processing card, additionally installed in the slot #4, is 2 A, the remaining consumption current of the power supply system PWR #1 is 1 A, and the remaining consumption current of the power supply system PWR #2 is 7 A. Therefore, the determination result for the power supply system PWR #1 at Step S421 is “No”, meanwhile the determination result for the power supply system PWR #2 at Step S421 is “Yes”. Thus, the power supply system PWR #2 is assigned to the slot #4. Then, at Step S427, the slot #4 is connected to the power supply system PWR #2.

Furthermore, for example, the connection control unit 141 updates the state of the display information table, illustrated in FIG. 8, to the state that is illustrated in FIG. 13 in order to output the message A at Step S433 of FIG. 10. FIG. 13 illustrates that the three card slots are assigned to and connected to the power supply system PWR #2. Furthermore, it is illustrated that, with regard to the power supply system PWR #2, the total of the maximum consumption currents of the three card slots, connected to the power supply system PWR #2, is 13 A (=9 A+2 A+2 A), and the remaining consumption current is 7 A (=20 A-13 A). Therefore, in the case of FIG. 13, the total consumption current of the processing cards, attached to the card slots, is 32 A (=19 A+13 A). The connection control unit 141 outputs the message A to the information notifying unit 142 on the basis of the contents of the display information table, illustrated in FIG. 13, and the information notifying unit 142 notifies the message A. Furthermore, the connection control unit 141 outputs the display information table, illustrated in FIG. 13, to the table storage unit 143, and the table storage unit 143 stores the display information table.

Example of the hardware configuration of the connection control unit and the processing card FIG. 14 is a diagram that illustrates an example of the hardware configuration of the connection control unit and the processing card according to the first embodiment.

The connection control unit 141 includes two resistors (10 k Ω), to which +3.3 V is applied, and one of the resistors is connected to an INFO1_1 terminal, included in the processing card, while the other one of the resistors is connected to an INFO1_2 terminal, included in the processing card. Furthermore, in the processing card, the connection state of the INFO1_1 terminal and the INFO1_2 terminal is one of the following states 1 to 4. In the state 1, both the INFO1_1 terminal and the INFO1_2 terminal are open. In the state 2, both the INFO1_1 terminal and the INFO1_2 terminal are connected to the GND via a resistor (0Ω). In the state 3, the INFO1_1 terminal is open, while the INFO1_2 terminal is connected to the GND via the resistor (0Ω). In the state 4, the INFO1_1 terminal is connected to the GND via the resistor (0Ω), while the INFO1_2 terminal is open. For example, FIG. 14 illustrates the state 3.

If the connection state of the INFO1_1 terminal and the INFO1_2 terminal of the processing card is the state 3, the connection control unit 141 detects +3.3 V as the INFO1_1 and 0 V as the INFO1_2, where the GND is a signal GND (SG). That is, the high level (H) is detected as the INFO1_1, and the low level (L) is detected as the INFO1_2. Therefore, as the connection state of each processing card is any one of the states 1 to 4, the connection control unit 141 may acquire the 2-bit information, i.e., any one of the “HH (11)” in the case of the state 1, “LL (00)” in the case of the state 2, “HL (10)” in the case of the state 3, and “LH (01)” in the case of the state 4. Then, the 2-bit information is the processing card information. Therefore, as each processing card has the connection state, which is any one of the states 1 to 4, the connection control unit 141 may discriminate among the four types of cards. For example, it is possible to discriminate among the four types of cards, i.e., the types A, B, C, and D. Therefore, as illustrated in FIG. 5, for example, if there are 26 types of cards, i.e., A to Z, the processing card may be provided with five terminals, i.e., INFO1_1 to INFO1_5, so that the connection control unit 141 may acquire 5-bit information.

As described above, according to the first embodiment, the base station equipment 10 includes the slots #1 to #N, the power supply systems PWR #1 to #M, and the connection control unit 141. The connection control unit 141 connects the card slots, to which the processing cards are attached, among the slots #1 to #N, to the number of power supply systems, which corresponds to the total consumption current of the processing cards, attached to the card slots, among the power supply systems PWR #1 to #M.

In this way, all the attached processing cards may be operated by using only the minimum number of power supply systems that correspond to the total consumption current of the attached processing cards, and therefore the number of used power supply terminals in the base station equipment 10 may be reduced. Hence, it is possible to reduce the number of power supply cables for connecting the base station equipment 10 and the power supply facility 20, and thus all the processing cards, attached to the base station equipment 10, may be operated by using the power supply facility 20, of which the number of storable power supply cables is small, i.e., the small-sized power supply facility 20. Therefore, the existing power supply facility 20 may be effectively used, and thus new construction of the power supply facility 20 may be suppressed.

Furthermore, the connection control unit 141 uses the single power supply system among the power supply systems PWR #1 to #M to detect whether a processing card is attached to the slots #1 to #N.

In this way, it is possible to detect whether a processing card is attached to the slots #1 to #N by using the minimum number of power supply terminals before the processing card is operated.

Furthermore, the connection control unit 141 connects the card slot, to which the processing card is attached, to the power supply system in accordance with the priority level of the processing card that is attached to the card slot.

In this way, as the priority level is different depending on each type of processing card, multiple processing cards of the same type may be connected to the same power supply system. Therefore, for example, multiple processing cards with the highest priority level may be connected to the single power supply system. For example, if the priority level of the processing card, which is needed for start-up of the base station equipment 10, is the highest, the base station equipment 10 may be restarted and recovered by using only the single power supply system during the occurrence of failure of the base station equipment 10.

Furthermore, the connection control unit 141 sequentially connects each of the power supply systems PWR #1 to #M to each of the card slots, to which the processing cards are attached, with an interval that is equal to or more than the initial time of each of the processing cards that are attached to the card slots.

In this way, it is possible to prevent an instant and excessive increase of the consumption current due to the start-up of multiple processing cards at once, as the consumption current increases largely for a moment during the start-up of the processing card; thus, turn-off of the breaker due to an excessive increase of the consumption current may be prevented.

Furthermore, the base station equipment 10 includes the information notifying unit 142. The information notifying unit 142 notifies the connection state between the slots #1 to #N and the power supply systems PWR #1 to #M.

Thus, in response to the notification from the information notifying unit 142, for example, the administrator of the base station equipment 10 may turn on the breaker, which is connected to the power supply system that supplies the current to the card slot.

### [b] Second Embodiment

In the second embodiment, an explanation is given of a case where, if the power-supply system number of p_set_max is not sufficient to cover the currents for operating all the processing cards, attached to the base station equipment 10, the deficiency number of the power supply systems with regard to p_set_max is notified.

Operation at the Time of Assignment of the Power Supply System

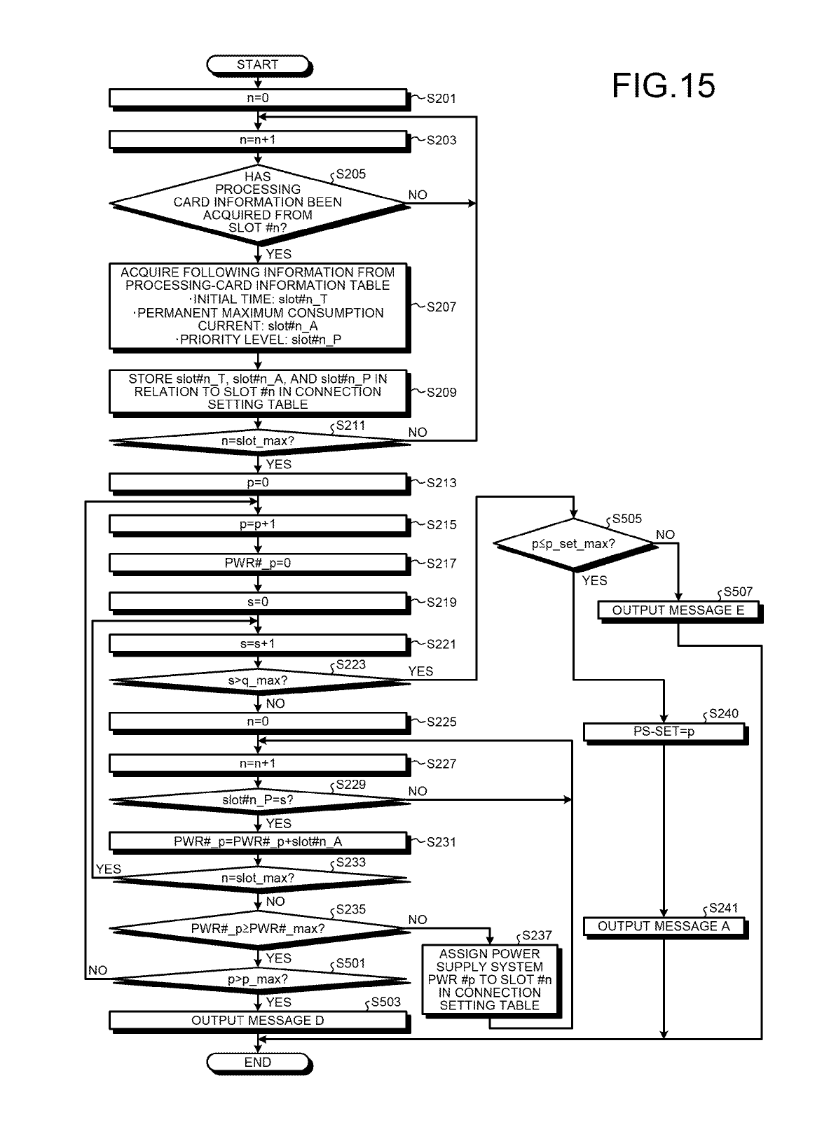

FIG. 15 is a flowchart that illustrates an example of the operation of the base station equipment according to the second embodiment. The flowchart illustrated in FIG. 15 is started, for example, when the power source of the base station equipment 10 is turned on, as is the case with the flowchart that is illustrated in FIG. 3. In FIG. 15, the same reference numeral as that in FIG. 3 is applied to the step for performing the same operation as that illustrated in FIG. 3, and the explanations are omitted.

At Step S501, the connection control unit 141 determines whether p is larger than p_max. As described above, p_max corresponds to the total number (i.e., the possessed system number) of power supply systems, included in the base station equipment 10, and it is acquired from the information that is previously stored in the memory that may be referred to by the connection control unit 141. If p is larger than p_max (Step S501: Yes), the operation proceeds to Step S503 and, if p is equal to or less than p_max (Step S501: No), the operation returns to Step S215 so that p is incremented.

At Step S503, the connection control unit 141 outputs a message D to the information notifying unit 142, and the information notifying unit 142 notifies the message D. The message D includes, for example, a message that notifies that the power-supply system number of p_max is not sufficient to cover the currents for operating all the processing cards, attached to the base station equipment 10, i.e., it is difficult to operate all the attached processing cards even by using all the power supply systems, included in the base station equipment 10. For example, the information notifying unit 142 may include multiple blue LEDs that indicate normal termination and multiple red LEDs that indicate faulty termination so that, by flashing all the red LEDs, the message D is notified.

If s is larger than q_max at Step S223 (Step S223: Yes), the operation proceeds to Step S505.

At Step S505, the connection control unit 141 determines whether p is equal to or less than p_set_max. If p is equal to or less than p_set_max (Step S505: Yes), the operation proceeds to Step S240 and, if p is larger than p_set_max (Step S505: No), the operation proceeds to Step S507. If the determination at Step S505 is “No”, the power-supply system number of p_set_max is not sufficient to cover the currents for operating all the processing cards, attached to the base station equipment 10, i.e., with the power-supply system number of p_set_max, the power-supply system number is insufficient.

Therefore, at Step S507, the connection control unit 141 outputs the value of “p-p_set_max” to the information notifying unit 142, and the information notifying unit 142 notifies the value of “p-p_set_max” so as to notify the deficiency number of the power supply systems with regard to p_set_max. For example, the information notifying unit 142 may include multiple blue LEDs that indicate normal termination and multiple red LEDs that indicate faulty termination so that, by lighting up the number of red LEDs, which is equivalent to the value of “p-p_set_max”, the deficiency number of the power supply systems with regard to p_set_max is notified.

Furthermore, instead of the maximum used system number, the number of already connected power supply systems may be set as p_set_max by the administrator of the base station equipment 10 or the connection control unit 141. If the number of already connected power supply systems is set as p_set_max, the value of “p-p_set_max”, notified by using a message E at Step S507, is equivalent to the deficiency number with regard to the present connection number, i.e., the number of power supply systems that need to be further connected.

### [c] Other Embodiments

The base station equipment is not a limitation of the communication devices, to which the disclosed technology is applicable. The disclosed technology is applicable to any communication devices that include multiple card slots and multiple power supply systems.

According to an aspect of the disclosure, it is possible to reduce the number of used power supply terminals in communication devices.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device comprising:
multiple card slots to which processing cards are attachable;
multiple power supply systems that are capable of supplying a current from a power source to each of the multiple card slots; and
a control unit that connects the card slot to which the processing card is attached among the multiple card slots to any of the multiple power supply systems, the number of power supply systems that is connected to the card slot to which the processing card is attached corresponding to a total consumption current of the processing card that is attached to the card slot.

2. The communication device according to claim 1, wherein the control unit uses a single power supply system among the multiple power supply systems to detect whether the processing card is attached to each of the multiple card slots.

3. The communication device according to claim 1, wherein the control unit connects the card slot to which the processing card is attached to any of the multiple power supply systems, in accordance with a priority level of the processing card that is attached to the card slot.

4. The communication device according to claim 1, wherein the control unit sequentially connects each of the multiple card slots to which the processing card is attached to each of the multiple power supply systems, with an interval that is equal to or more than an initial start-up time of each of the processing cards that are attached to the multiple card slots.

5. The communication device according to claim 1, further comprising a notifying unit that notifies a connection state between the multiple card slots and the multiple power supply systems.
